(19) United States
(12) Patent Application Publication
(10) Pub. No.: US 2018/0218296 A1
(43) Pub. Date: Aug. 2, 2018

(54) METHOD FOR PLANNING AND PRODUCING AN ASSEMBLED PRODUCT, PRODUCTION MODULE, AND PRODUCTION CONTROL

(71) Applicant: SIEMENS AKTIENGESELLSCHAFT, München (DE)

(72) Inventors: Wendelin Feiten, Neubiberg (DE); Gisbert Lawitzky, München (DE); Michael Pirker, Lenggries (DE); Kai Wurm, München (DE); Vladimir Zahorcak, Borinka (SK)

(21) Appl. No.: 15/701,700

(22) PCT Filed: Mar. 15, 2016
(86) PCT No.: PCT/EP2016/055579

§ 371 Date: Sep. 12, 2017

(30) Foreign Application Priority Data
Mar. 23, 2015 (DE) 10 2015 205 173.0

(51) Int. Cl. G06Q 10/06; G06Q 50/04; G05B 19/4099

(52) U.S. Cl. CPC G06Q 10/067; G05B 2219/49023; G05B 19/4099; G06Q 50/04

(57) ABSTRACT

A product model data set with data for production steps to be carried out for the product and sub-products thereof is generated and assigned to a product copy to be produced. Data on a production step is read from the product model data set, and a production module which is available for carrying out the production step is ascertained. If the production step models a sub-product, a sub-product model data set is generated using the product model data set and transmitted to the ascertained production module. If the production step is an assembly step, each ascertained production module is entered into sub-product model data sets as the transport destination for the respective sub-product copy. If the production step can be carried out by the ascertained production module on a product copy, a transport destination is ascertained for the product copy from the product model data set.

### CROSS-REFERENCE TO RELATED APPLICATIONS

This application claims priority to PCT Application No. PCT/EP2016/055579, having a filing date of Mar. 15, 2016, based off of German application No. DE 102015205173.0 having a filing date of Mar. 23, 2015, the entire contents of which are hereby incorporated by reference.

### FIELD OF TECHNOLOGY

As a rule, contemporary production systems for manufacturing or processing technical products comprise a number of specific interacting production modules and are increasingly more complex. As a rule, a number of processing, production, assembly or handling steps are carried out on a product that is to be produced, processed or assembled, for which a number of appropriately specialized production modules are provided in the production system, such as for example robots, CNC machines, 3D printers, reactors, burners, heating systems or conveyor belts. As a rule, assembled products are assembled by assembling a plurality of intermediate products.

### BACKGROUND

It is known to plan and carry out production processes for a production system by means of central planning and implementation entities. During this, complex assembled products are often geometrically modelled by means of so-called CAD systems. However, as a rule the planning of a specific procedural process of the assembly and processing of the assembled products by a complex production system requires a number of further user decisions and user interventions. In particular, the specialized production modules of a production system are often to be programmed in a module-specific and/or product-specific way by relevant experts.

Accordingly, such production can often only be adapted to changing products or changing production loads with some planning effort and/or programming effort. Such adjustments can lead to downtimes or delays in production.

### SUMMARY

An aspect relates to specifying a method for producing an assembled product and a production module and a production control that can respond flexibly to changes during production.

An object of the embodiments of the invention is also to provide a computer program product, comprising a computer readable hardware storage device having computer readable program code stored therein, said program code executable by a processor of a computer system to implement a method established for carrying out a method.

According to embodiments of the invention, for producing a product assembled from a plurality of sub products in a production system comprising a plurality of production modules, it is provided to produce a product model data set with data relating to production steps to be carried out for the product and the sub products thereof and to assign said product model data set to an example product to be produced. Such a product can for example be a workpiece or product in various phases of a manufacturing, machining or processing process and in particular also an initial, preliminary, intermediate or end product. A respective production module can in particular be a device of the production system for contributing to the production, machining, assembly, processing and/or handling of the product, for example a robot, a CNC machine, a 3D printer, a reactor, a burner, a heating system, a conveyor belt or another transport module. According to embodiments of the invention, data relating to a production step are read out from the product model data set and an available production module for carrying out the production step is determined. During this, if the production step is modeling a sub product, a sub product model data set is produced using the product model data set, is assigned to a sub product item to be produced and is transmitted to the determined production module. If the production step is an assembly step for assembling sub product items, the determined production module is registered as the transport destination for the respective sub product items in sub product model data sets produced for the sub product items. If the production step can be performed by the determined production module on a product item that is available there, the production step is carried out, a transport destination for the product item is determined from the product model data set and the product item is forwarded to the determined transport destination. The sub product model data sets are each processed essentially as the product model data set was processed.

A significant advantage of embodiments of the invention is that as a rule, no central planning entity is necessary for the organization of specific production and assembly processes. In particular, as a rule assembly steps and other production steps can be assigned by distributed processes to specific production means and carried out there without user intervention. Thus, embodiments of the invention enable a flexible and rapid response to changes during production.

According to one advantageous embodiment of the invention, a product model, using which the product model data set for a respective product item is produced, can be assigned to the product to be produced. Such product models and the sub models thereof can often be reusable and in particular assembled to form new product models. This enables product modelling to be significantly facilitated in many cases.

Advantageously, the product model data set can be produced as a programmatic entity of the product model, preferably in the sense of object-oriented programming.

Furthermore, the product model can comprise a formal semantic description of the production steps to be carried out for the product and the sub products thereof. Owing to the description at the semantic level, the same product model can be used on different production systems.

Furthermore, the product model can be transmitted to a first production module, which produces the product model data set and initiates the processing thereof.

According to an advantageous embodiment of the invention, the product model data set can be stored with an assigned product item and/or in association with an identifier applied to the product item. In particular, the product model data set or the identifier can be stored at least partly in a so-called RFID chip (RFID: Radio-Frequency Identification) that is attached to the product item. This enables a product to control its own production in the production system, so to speak.

Furthermore, the product model data set can comprise a specific production model data set for storing the data relating to the production steps to be carried out and/or a data set concerning an identifier, a type, a position, dimensions, a status and/or routes travelled or to be travelled by the associated product item in the production system.

Moreover, sequence information about an implementation sequence of the production steps can be assigned to the production steps in the product model data set.

Furthermore, for determining the available production module for carrying out the production step, the production step can be compared with capabilities of production modules of the production system and/or the availability can be managed dynamically and/or distributively with production modules of the production system. This enables control of the production process that is distributed and adapted to current availabilities. As a rule, temporary failures or overloads of individual production modules can be taken into account and circumvented in an ad hoc manner without user intervention.

Preferably, the capabilities and availabilities of the production modules can be determined using a formal semantic model of the production system that comprises a description of production services of the production modules, state information about operating states of the production modules and/or transport information about transport routes to or from the production modules. Owing to the description at the semantic level, the model of the production system can be used for production modules across the production system.

According to a further advantageous embodiment of the invention, the product model data set can be managed for a product item that is to be produced as a virtual product item that is assigned to the produced product item following the production of the product item. The management of virtual product items as information media enables the efficient distributed organization of assembly processes and other production processes.

In particular, a product item assembled from sub product items can be associated with the virtual product item that was used to initiate the generation of the sub product model data sets for the sub product items.

Furthermore, a production module that produces a sub product model data set can register said production module as the transport destination for the associated sub product item in the sub product model data set and can initiate the processing thereof. In this way, distributively produced sub product items find their way to the production module that assembles the sub product items without identifying each other, so to speak.

Moreover, sub product information about produced sub product model data sets and/or sensor data or data that are derived therefrom over a production process are stored in the product model data set. This can be used for efficient quality assurance in many cases.

### BRIEF DESCRIPTION

Some of the embodiments will be described in detail, with reference to the following figures, wherein like designations denote like members, wherein:

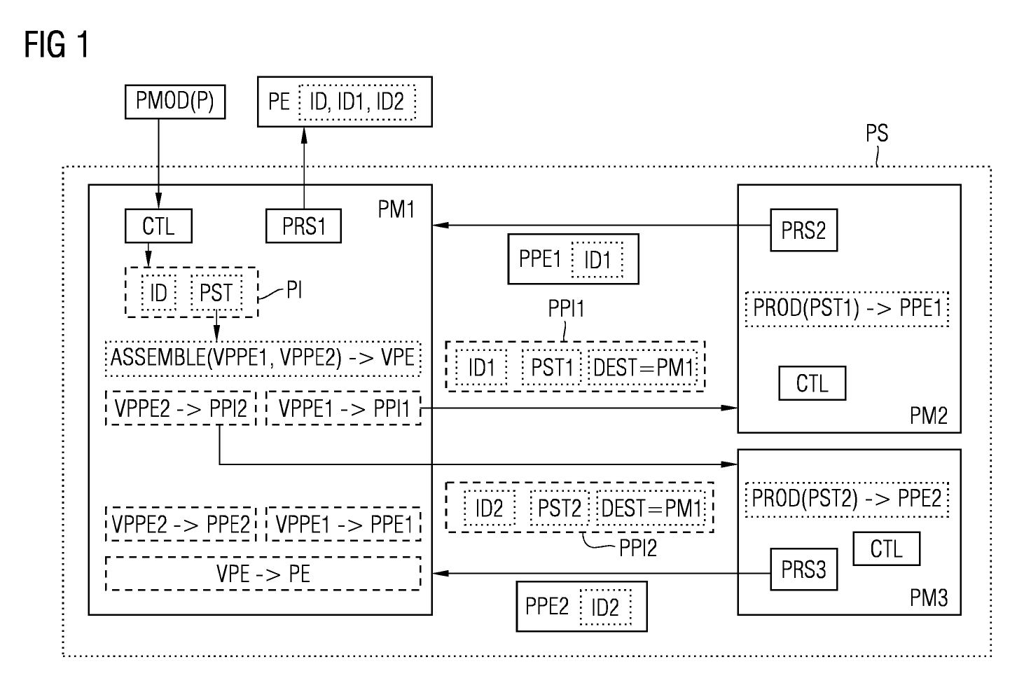

FIG. 1 shows a production system with a plurality of production modules for producing an assembled product;

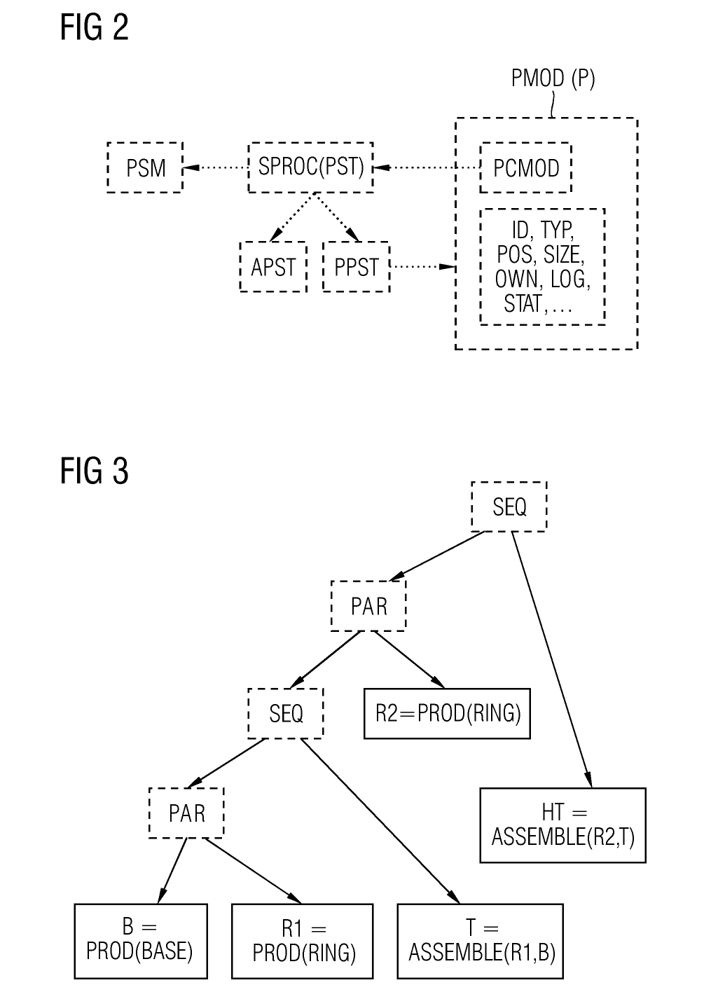

FIG. 2 shows a semantic product model for a product to be produced;

FIG. 3 shows a structural production description for producing the product; and

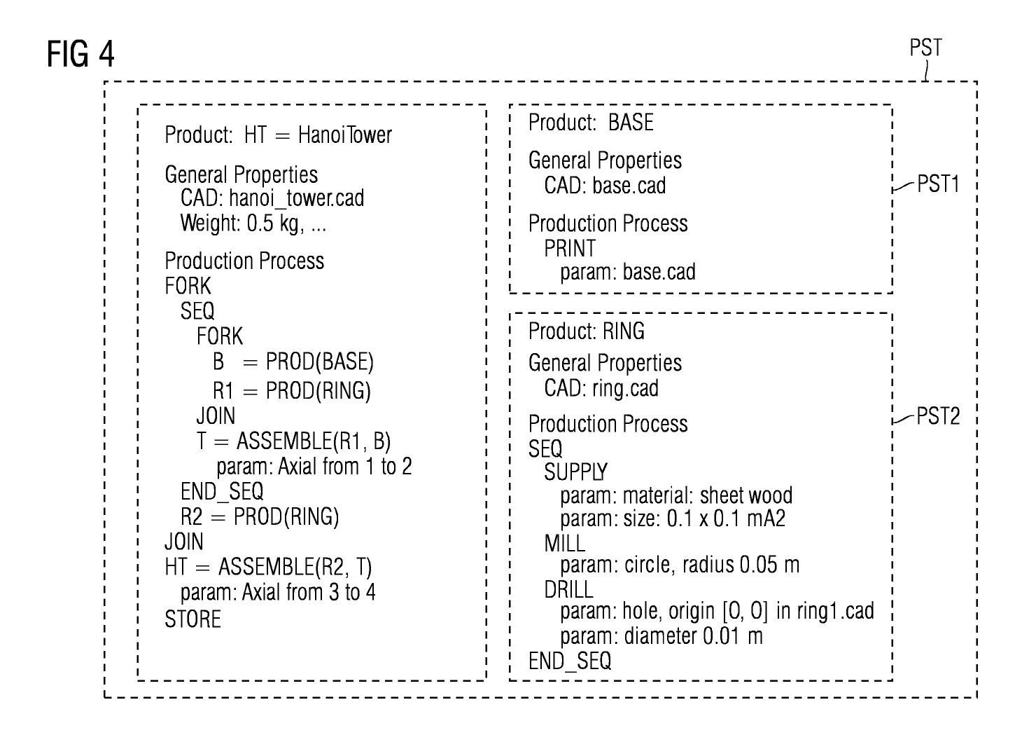

FIG. 4 shows a procedural production description for producing the product.

### DETAILED DESCRIPTION

FIG. 1 illustrates a production system PS according to embodiments of the invention with a number of production modules, in this case PM1, PM2 and PM3, for producing a product P assembled from a plurality of sub products. The product P and the sub products thereof can each be an arbitrary physical product or sub product or workpiece in various phases of a manufacturing, machining and/or processing process, in particular also an initial, preliminary, intermediate or end product. The production system PS can be a manufacturing plant, for example.

In particular, devices of the production system PS can be provided as production modules PM1, PM2 and PM3, which contribute to production, machining, assembly, processing and/or handling of the product P and/or the sub products thereof. In this case, the production modules PM1, PM2 and PM3 can each comprise specific functionality. Examples of this are in particular robots, CNC machines, 3D printers, reactors, burners, heating systems and conveyor belts or other transport modules. In particular, the production modules PM1, PM2 and PM3 can be so-called Cyber Physical Modules (CPM) or Cyber Physical Production Modules (CPPM).

The production modules PM1, PM2 and PM3 each contain a production control means CTL, in order inter alia to control a process of the production of products. In the present exemplary embodiment, the production control means CTL is part of a respective production module PM1, PM2 or PM3 in each case. Alternatively or additionally, the production control means CTL can also be a central or distributed part of the entire production system PS. A module-specific production control means CTL enables distributed process control, which in many cases can respond very flexibly and rapidly to changes in the production process.

The production modules PM1, PM2 and PM3 each provide a specific production service PRS1, PRS2 or PRS3 in the production system PS. For example, the provision of material, drilling, grinding, milling, the assembly of sub product items and/or transport services can be provided as production services PRS1, PRS2 or PRS3.

For production of the product P, a product model PMOD is transmitted to a first production module, in this case PM1, of the production system PS. The product model PMOD is assigned to the product to be produced P and comprises a formal semantic description of the production steps to be carried out for the product and the sub products thereof. Using the product model PMOD, a product model data set PI is produced as a programmatic entity of the product model, preferably in the sense of object-oriented programming, by the production control means CTL of the production module PM1. The product model data set PI is assigned to a specific product item to be produced. Said product item to be produced or the associated product model data set PI is managed as a virtual product item VPE if the product item has not yet been produced. Once a product item PE has been physically produced using the product model data set PI, the produced product item PE is assigned to the virtual product item VPE. The same applies to sub products of the product P that are to be produced, inasmuch as a sub product item that is to be produced or an associated sub product model data set PPI1 or PPI2 is managed as a virtual sub product item VPPE1 or VPPE2, as long as the sub product item has not yet been physically produced. Following the physical production, the sub product model data set PPI1 or PPI2 or the virtual sub product item VPPE1 or VPPE2 is assigned to the produced sub product item PPE1 or PPE2.

The product model data set PI comprises an identifier ID that uniquely identifies a respective product item PE. This can be a serial number, for example. Corresponding unique identifiers ID1 and ID2 are provided for the sub product items PPE1 and PPE2. Furthermore, the product model data set PI comprises data relating to production steps PST that are to be carried out for producing the product P, for example a description of machining, assembly, manufacturing, provisioning and transport processes and/or a description of the production services necessary for this.

At least some of the production steps PST are read out from the product model data set PI and checked by the production module PM1. In this case, it is in particular determined which production module of the production system PS is available for carrying out a respective production step. For this purpose, a respective production step is compared with capabilities of the production modules of the production system PS, and in the case of suitability of a production module, the availability thereof is negotiated dynamically. During this, the capabilities and availabilities of the production modules are determined using a formal semantic model of the production system PS.

If a respective production step can be physically carried out by the determined production module on a product item that is present or detected there, the implementation of the production step by the production module PM1 is initiated.

If the checked production step is modeling a sub product, using the product model data set PI, a sub product model data set, in this case PPI1 or PPI2, is produced, assigned to a sub product item that is to be produced, in this case VPPE1 or VPPE2, and transmitted to the determined production module, in this case PM2 or PM3.

If the checked production step is an assembly step for assembling sub product items, the production module, in this case PM1, that is determined for implementation of the assembly step is registered as the transport destination DEST for the produced sub product items, in this case PPE1, PPE2, in the sub product model data sets, in this case PPI1, PPI2, that are produced for the virtual sub product items, in this case VPPE1, VPPE2.

In the present exemplary embodiment, the production steps PST include an assembly step ASSEMBLE as a specific production step for assembling the sub product items VPPE1 and VPPE2 that are to be produced, i.e. the virtual sub product items. During the checking of the assembly step ASSEMBLE, it is determined that the production module PM1 itself is available for implementation of the assembly step ASSEMBLE. Thus, the implementation is initiated there. The product item to be assembled by the assembly step ASSEMBLE is managed up to the actual production thereof as a virtual product item VPE in association with the product model data set PI. As the sub product items to be assembled VPPE1, VPPE2 have not yet been produced, the production thereof is initiated by the production module PM1. For this purpose, for each virtual sub product item VPPE1 or VPPE2, the sub product model data set PPI1 or PPI2 is produced using the product model data set PI. The sub product model data set PPI1 or PPI2 contains a semantic description of the production steps to be carried out for the respective sub product and the sub products thereof. The product model data set PI and/or the sub product model data sets PPI1, PPI2 can thus contain further recursive sub product model data sets and/or can be assigned thereto.

In the present exemplary embodiment, the sub product model data set PPI1 comprises an identifier ID1 that uniquely identifies the virtual sub product item VPPE1 to be produced and the sub product item PPE1 produced. Furthermore, the sub product model data set PPI1 comprises a description of the production steps PST1 that are to be carried out for producing the sub product unit VPPE1. The production module PM1 that has instantiated the sub product model data set PPI1 is the production module that is registered as the transport destination DEST for the produced sub product item PPE1 in the sub product model data set PPI1. The sub product model data set PPI1 is transmitted from the production module PM1 to the production module PM2 that is available for the manufacture of the sub product unit PPE1.

The sub product model data set PPI2 generated for the virtual sub product item VPPE2 to be produced is produced similarly to the sub product model data set PPI1 and comprises corresponding data related to the sub product item VPPE2 to be produced. The production module PM1 that has instantiated the sub product model data set PPI2 is registered as the transport destination DEST for the produced sub product item PPE2. The sub product model data set PPI2 is transmitted from the production module PM1 to the production module PM3 that is available for the manufacture of the sub product item VPPE2.

The production module PM2 reads out the description of the production steps PST1 from the received sub product model data set PPI1 and carries out a specific production step PROD for manufacturing and/or provisioning the sub product unit VPPE1 that is to be produced. The production step PROD is carried out by the production service PRS2, which provides the produced sub product item PPI1 to further production modules of the production system PS, possibly following recursive delegation of further sub production processes. The produced sub product item PPE1 is provided with the identifier ID1 contained in the sub product model data set PPI1 and is transported from the production service PRS2 to the transport destination DEST specified in the sub product model data set PPI1, i.e. to the production module PM1.

In a similar manner, the sub product item PPE2 is provided by the production service PRS3 of the production module PM3, possibly after recursive delegation of sub production processes. The sub product item PPE2 is provided with the identifier ID2 contained in the sub product model data set PPI2 and is transported from the production service PRS3 to the transport destination DEST specified in the sub product model data set PPI2, i.e. to the production module PM1.

After the arrival of the respective sub product unit PPE1 or PPE2, the sub product model data set PPI1 or PPI2 that is managed as a virtual sub product item VPPE1 or VPPE2 is assigned to the produced sub product item PPE1 or PPE2 by the production module PM1. Thereupon, the produced sub product items PPE1 and PPE2 are assembled by the production service PRS1 according to the assembly step ASSEMBLE to form the product item PE. The product model data set PI that is managed as a virtual product item VPE is assigned to the produced product item PE during this. The produced product item PE is provided with the identifier ID and with the identifiers ID1 and ID2 of the sub product items and is transported from the production system PS, for example into a product store.

FIG. 2 shows a semantic product model PMOD for a product P or sub product that is to be produced in a schematic representation. In the following, the term product or product item can also mean a sub product or a sub product item. In FIG. 2, dashed rectangles each characterize a so-called ontology concept. In this case, a dotted arrow from a first to a second ontology concept indicates that the first ontology concept is described by the second ontology concept.

An ontology concept for the product model PMOD comprises a production model PCMOD that contains a formal semantic description of the production steps to be carried out for the product P and the sub products thereof. Furthermore, the product model PMOD comprises an identifier ID for the unique identification of a respective product item, for example a serial number, type information TYP for specifying a product type of a respective product item, position information POS about a spatial position of a respective product item, geometric information SIZE about dimensions of a respective product item and/or of substructures of the product item, affiliation information OWN about the affiliation of a respective product item, process information LOG about a production process and/or about routes of the respective product item stored or to be stored in the production system PS and/or state information STAT about a state of the respective product item. Further data for the description of the product or the production thereof may possibly be formed in the product model PMOD.

The production model PCMOD is described by a formal semantic description SPROC of the production steps PST to be carried out for the product and the sub products thereof.

Such a semantic description specifies in particular the meaning of the production steps PST. The semantic description SPROC describes the production step PST in such a way that the production steps PST can be carried out on different systems and/or system-wide.

The semantic description SPROC is based on a semantic description APST of so-called atomic production steps. The latter are production steps that cannot be usefully divided further and that can be carried out by a production module directly on a product item. Furthermore, the semantic description SPROC is based on a formal semantic description PPST of modelled sub products. The semantic description PPST is in turn based on product models PMOD of the respective sub products.

Furthermore, the semantic description SPROC is based on a formal semantic model PSM of the production system PS. The semantic model PSM can in particular comprise a semantic description of production services of the production modules, state information about operating states of the production modules and/or transport information about transport routes to or from the production modules.

FIG. 3 shows a structural production description for producing the product in a schematic representation. For the present exemplary embodiment, it is assumed that the product to be produced is a so-called tower of Hanoi HT. The product HT comprises a base BASE of the tower of Hanoi and a ring RING as sub products. A sub product item B is to be produced from the base BASE. Furthermore, a first ring R1 and a second ring R2 are to be manufactured as sub product items from the sub product RING. An intermediate product item T is to be assembled from the sub product items B and R1. The sub product items B, R1, R2 and T are each represented by an individual sub product model data set, as described in connection with FIG. 1. Prior to production of the sub product items, the associated sub product model data sets are managed as virtual sub product items.

A specific production step PROD is provided for producing the sub product items in each case. For assembly of the produced sub product items, a specific production step ASSEMBLE is provided. An implementation sequence of the production steps is controlled by control operations SEQ and PAR, which together form a sequence information item. The control operation SEQ thus causes a sequential performance of production steps, whereas the control operation PAR causes or at least attempts a parallel performance. As a rule, production steps that can be carried out mutually independently are performed in parallel. Moreover, further control operations, for example for controlling an alternative and/or conditional performance of two or more production steps, can also be provided.

According to FIG. 3, the sub product item B is produced by carrying out the production step PROD(BASE) for the sub product BASE. Said production step PROD(BASE) is carried out in parallel with a production step PROD(R1), by which the first ring R1 is produced. Following the parallel production of the sub products B and R1, the intermediate product item T is assembled from the sub product items R1 and B by the assembly step ASSEMBLE(R1,B). Said assembly is carried out in turn in parallel with the production of the second ring R2 by the production step PROD(RING). Following the performance of said parallel production steps, the sub product items T and R2 are finally assembled by means of the assembly steps ASSEMBLE(R2,T) to form the tower of Hanoi HT.

FIG. 4 shows a procedural production description for producing a product in a schematic representation. The product to be produced is the tower of Hanoi HT as described in connection with FIG. 3. FIG. 4 illustrates a description of the production steps PST to be carried out for the product HT and for the sub products thereof BASE and RING. For the production of the sub product BASE, in this case the production steps PST1 are carried out and the production steps PST2 are carried out for production of the sub product RING.

The production description contains control operators FORK, JOIN, SEQ and END_SEQ. In this case, the control operators FORK and JOIN form a splitting or joining of production processes that are carried out in parallel. By contrast, the control operators SEQ and END_SEQ form the start and end of a sequential chain of production processes. The same reference characters are assigned in FIG. 4 to the sub product items B, R1, R2 and T represented in FIG. 3, likewise the specific production steps PROD and ASSEMBLE and the sub products BASE and RING.

Furthermore, the production steps PST comprise atomic production steps PRINT, SUPPLY, MILL and DRILL. Moreover, for a respective atomic production step, production step-specific parameters param are specified. Of the atomic production steps, PRINT controls a printout, SUPPLY controls the provision of material or of a preliminary product, MILL controls a milling process and DRILL controls a drilling process on a respective product item.

With the descriptive elements specified above, FIG. 4 is self-explanatory.

According to embodiments of the invention, formal semantic models describe the production process. These are in particular the production model PCMOD and the product model PMOD, which preferably constitute a complete specification of the product P. The production model PCMOD is part of the product model PMOD and preferably comprises a complete specification of the production process and in particular of the assembly process. The semantic models PMOD and PCMOD are machine-readable and machine-interpretable. In the model of the assembly process, the control flow of the assembly is specified by the control operators SEQ, PAR etc. The product P thus controls, so to speak, its own assembly or production using the product model PMOD or production model PCMOD thereof and by means of the formal semantic model PSM of the production model PS.

The production of the product item PE is initiated by transmitting the product model PMOD to a production module that is determined to be suitable, in this case PM1, and by said production module initializing a specific entity of the product model PMOD in the form of the product model data set PI. Said product model entity PI is assigned to the specific product item to be produced, i.e. VPE prior to the production and PE following the production. Such a production module, in this case PM1, instantiating the production of the product P can be an outgoing storage facility, an assembly unit and/or a machining station, for example.

The production description, i.e. the description of the production steps PST, is processed step-by-step in the relevant production module. If the production step proves to be atomic, a production module that is available for implementation of the atomic production step is determined and the atomic production step is carried out there. The performance of the atomic production step is carried out during this by calling up a so-called production service of the determined production module. In this case, assembly steps are modelled as atomic in a production module as with producing steps.

If the production step to be carried out proves not to be atomic, but is modeling a sub product, an instance of the corresponding sub product is initiated by a production module that is determined to be suitable and available. The last-mentioned production module then uses the same instructions for the step-by-step processing of the production steps for the sub product. In this way, assembled products are divided into sub products until the resulting sub products can be produced or machined by atomic production steps and can be formed with the production resources of the production system PS.

Advantageously, for a respective product item, data are stored for each or at least for a large part of the performed production steps. For this purpose, sensor data or variables derived therefrom can also be stored. Storing the production process of a respective product item enables efficient quality assurance. If a plurality of sub product items are fitted to a product item, a respective identity of the sub product items is preferably retained and is associated with the assembled product item.

Each sub product item that is part of an assembled product item or another sub product unit is combined with the other sub product items that are also part of the same assembled product item or sub product item. For this purpose, for each sub product item that is initiated by a respective production module, said production module is preferably registered as the transport destination in the respective sub product model data set. Such a transport destination can for example be registered as an atomic transport step in the production description.

Preferably, during assembly processes the assembled product item PE or sub product item PPTE1, PPTE2 is assigned to the virtual product item VPE or sub product item VPPE1, VPPE2 that has caused the expansion of the production plan into sub production steps. The virtual product item waits for the associated physical product item, so to speak, in the relevant production module. Said organization is advantageous inasmuch as the flow of product data and sub product data can be controlled better. In this way, the sub product items only have to receive the information that is necessary for the specific respective production. The management of virtual product items as information media in distributed production systems enables the efficient distributed organization of assembly and production processes.

Owing to the description of the production at a semantic level, the same product model can be used for different production systems. In particular, a production and assembly plan can be automatically derived in an efficient manner from the product model PMOD, and as a rule without user intervention and without a higher-level planning entity. The effort of setting up the production system PS is considerably reduced through this. Furthermore, once set up, product models and the sub models thereof can often be reusable. In particular, in this way previously set up sub product models can be assembled to form new product models. This can considerably facilitate product modelling in many cases. The distributed, automatic and flexible production organization enables rapid adaptation to changing production loads and to different products.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for producing a product assembled from a plurality of sub products in a production system comprising a plurality of production modules, wherein
a) producing a product model data set with data relating to the production steps to be carried out for the product and the sub products thereof and is assigned to a product item that is to be produced,
b) reading data relating to a production step out from the product model data set and an available production module for carrying out the production step is determined, wherein
i) if the production step is modeling a sub product, producing a sub product model data set using the product model data set, is assigned to a sub product item that is to be produced and is transmitted to the determined production module,
ii) if the production step is an assembly step for assembling sub product items, registering the respective determined production module as the transport destination for the respective sub product item in sub product model data sets that are produced for the sub product items, and
iii) if the production step can be carried out by the determined production module on a product item that is provided there, the production step is carried out, determining a transport destination for the product item from the product model data set and the product item is forwarded to the determined transport destination, and
c) processing each of the sub product model data sets substantially as the product model data set.

2. The method as claimed in claim 1, wherein a product model is assigned to the product to be produced, using which the product model data set for a respective product item is produced.

3. The method as claimed in claim 2, wherein the product model data set is produced as a programmatic entity of the product model in each case.

4. The method as claimed in claim 2, wherein the product model comprises a formal semantic description of the production steps to be carried out for the product and the sub products thereof.

5. The method as claimed in claim 2, wherein the product model is transmitted to a first production module that produces the product model data set and initiates the processing thereof.

6. The method as claimed in claim 1, wherein the product model data set is stored with the associated product item and/or in association with an identifier attached to the product item.

7. The method as claimed in claim 1, wherein the product model data set comprises a specific production model data set for storing the data relating to the production steps to be carried out and/or a data set relating to an identifier, a type, a position, dimensions, a status and/or routes of the associated product item that are stored or that are to be stored in the production system.

8. The method as claimed in claim 1, wherein sequence information relating to an implementation sequence of the production steps is assigned to the production steps in the product model data set.

9. The method as claimed in claim 1, wherein determining the available production module for carrying out the production step, the production step is compared with capabilities of production modules of the production system and/or the availability is dynamically and/or distributively negotiated with production modules of the production system.

10. The method as claimed in claim 9, wherein the capabilities and availabilities of the production modules are determined using a formal semantic model of the production system that comprises a description of production services of the production modules, state information about operating states of the production modules and/or transport information about transport routes to or from the production modules.

11. The method as claimed in claim 1, wherein the product model data set for a product item that is to be produced is managed as a virtual product item to which the produced product item is assigned following production of the product item.

12. The method as claimed in claim 1, wherein a product item assembled from sub product items is assigned to the virtual product item, using which the generation of the sub project model data sets for the sub product items has been initiated.

13. The method as claimed in claim 1, wherein a production module that produces a sub product model data set enters said production module as the transport destination for the associated sub product item in the sub product model data set and initiates the processing thereof.

14. The method as claimed in claim 1, wherein sub product information about produced sub product model data sets and/or sensor data or data derived therefrom relating to a production process are stored in the product model data set.

15. A production module for a production system, established for carrying out a method as claimed in claim 1.

16. A production control for a production system, established for carrying out a method as claimed in claim 1.

17. A computer program product comprising a computer readable hardware storage device having computer readable program code stored therein, said program code executable by a processor of a computer system to implement a method established for carrying out a method as claimed in claim 1.
